(19) United States
(12) Patent Application Publication
(10) Pub. No.: US 2012/0298654 A1
(43) Pub. Date: Nov. 29, 2012

(54) Method and System for Reducing Distructive Forces of a Hurricane

(76) Inventor: Qasem Al-Qaffas, Alsalam Area (KW)

(21) Appl. No.: 13/116,563

(22) Filed: May 26, 2011

(51) Int. Cl. H05B 6/10; A01G 15/00

(52) U.S. Cl. 219/635; 239/14.1

(57) ABSTRACT

A method for reducing the destructive force of a hurricane includes and/or consists of the steps of providing a pair of magnetrons, each of which produces a frequency of 2,450 mghz at 1,000 to 3,000 watts and deploying the magnetron in space over a coastal area. The method also includes the step of producing a source of electrical energy such as solar cells that produces between 1,000 and 3,000 watts for powering the magnetrons and deploying the source of energy in orbit in the proximity of the magnetron. Finally, the method includes the step of producing a frequency of 2,450 mghz and directing or focusing the frequency on the air surrounding the eye of a hurricane as the hurricane approaches a coastal area and at an upper level of the hurricane.

This invention relates to a method and system for reducing the destructive forces of a hurricane and more particularly to a method and system that incorporates a magnetron to heat coastal upper air in the vicinity of a hurricane to thereby reduce the temperature differential and condensation of moisture.

### BACKGROUND FOR THE INVENTION

A hurricane is a storm system that is characterized by a large low pressure center and a plurality of thunderstorms that produce strong winds and heavy rain. For many years, hurricanes have been studied because of their destructive forces and often because of the devastating damage as for example caused by Katrina on New Orleans in 2005, Katrina was estimated to be the costliest natural disaster and one of our most deadly in U.S. history. By contrast, hurricane Andrew, which struck Southern Florida and South Central Louisiana caused damages in the amount of 26 billion dollars in 1992 dollars and killed about 65 people.

In a September 2008 issue of Nature a report indicated that hurricanes are getting stronger, particularly over the North Atlantic and Indian oceans. Wind speeds for the strongest tropical storms increased from an average of 140 mph in 1981 to 156 mph in 2006. At the same time the ocean temperature averaged globally over all regions where tropical cyclone increased from 28.2° C. to about 28.5° C.

As the cost for hurricane damages and the loss of life have increased, there have been numerous attempts to protect people and property from the devastating results of major hurricanes. For example, A U.S. Pat. No. 3,683,627 of Girden discloses an improved means and method for raising sub-surface water to the surface of a body of water for manifold purposes. By dissolving air in the water and providing excess air, the water rises in a vertical current and is accelerated as the pressure on the water at various levels decreases toward the surface, causing the water to give off the dissolved air in a multitude of tiny bubbles which further accelerates the flow of water to the surface. As stated in the patent, by using the techniques of the invention, the cooler sub-surface water can be brought to the surface to balance the heat and pressure development of the hurricane. For example, 500 square miles of cooled ocean surface would represent 1,500,000 square miles of air as the specific heat of water is more than 3,000 times that of air. Therefore, 500 square miles of cooled ocean water can be sufficient to balance the heat causing the hurricane.

A more recent U.S. Pat. No. 5,441,200 of Rovella II entitled “Tropical Cyclone Disruption” discloses a chemical which allows water to chemically join its crystalline lattice is applied to the eye wall of a tropical cyclone to initiate a self destructive catalyzing effect. If applied in powdered form to the upper, center portions of the eye wall, the effect will be greater. Water vapor within the eye wall chemically joins the lattice of the chemical. These larger molecules will also develop through collision and coalesce. Now the vapor of the eye wall is heavier and will spin outwards from Centrifugal Force. As a result of the larger eye, barometric pressure in the eye increases, wind speed slows, and the storm surge decreases to minimal proportions.

Finally, a U.S. Pat. No. 7,726,601 of Hershkovitz discloses a device and method for affecting local climatic parameters. As disclosed, the system comprises a sunlight radiation reflecting surface and a propulsion mechanism wherein the propulsion mechanism is adapted to move a reflective surface to a predetermined position based on the effect of the system on local parameters at that position.

Notwithstanding the above, it is presently believed that there is a need and a potential commercial market for an improved method and system for reducing the destructive forces of a hurricane in accordance with the present invention. There should be a need and a commercial market for coping with what otherwise could be a damaging storm with catastrophic costs and loss of lives. It is further believed that the use of the present invention will enable communities to reduce the severity of such storms and at the same time receive the benefits of additional moisture.

### BRIEF SUMMARY OF THE INVENTION

In essence a method for reducing the destructive forces of a hurricane comprise the steps of: providing a magnetron that produces a frequency of about 2,450 mghz at 1,000 to 3,000 watts and deploying the magnetron in space over a coastal area. The method also includes the step of directing rays from the magnetron toward a layer of air in the projected path of a hurricane to reduce the temperature differential between the cold upper air and the warm region.

A second embodiment of the invention contemplates a method for reducing the destructive forces of a hurricane if not the elimination of a hurricane during its initial or early formative stages. The method includes or consists of providing a magnetron that produces a frequency of about 2,450 mghz at about 1,000 to 3,000 watts and mounting the magnetron in an aircraft of the type that is used by the weather service to fly into the eye of a hurricane. The aircraft is flown at an altitude slightly above the hurricane and directs the rays from the magnetron at the base of the eye wall of an early stage hurricane.

In a preferred form of the second embodiment of the invention the aircraft is flown above the hurricane and the rays are directed at the upper area of the hurricane to further reduce the power of the hurricane.

In a further embodiment of the invention a pair of magnetrons of the aforementioned type are disposed in the aircraft and positioned to direct the rays of one magnetron toward the base of an eye wall of the hurricane and to direct the rays from the second magnetron at an upper portion of the hurricane.

The invention will now be described in connection with the accompanying drawings wherein like reference numerals have been used to indicate like parts.

### DESCRIPTION OF THE DRAWINGS

FIG. 1 is a schematic illustration of a hurricane with two magnetrons disposed above the hurricane and wherein one of the magnetrons includes a plurality of solar cells and a portion of a rocket body;

FIG. 2 is a schematic illustration of a magnetron and array of solar cells deployed in orbit above a hurricane; and

FIG. 3 is a flow chart illustrating a method in accordance with the present invention;

### DESCRIPTION OF THE PREFERRED EMBODIMENTS OF THE INVENTION

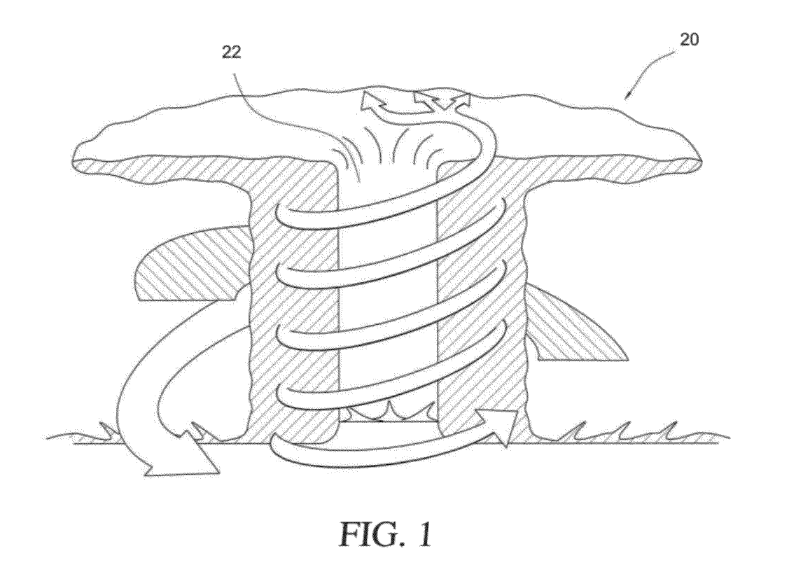

As illustrated in FIG. 1, a hurricane 20 of the type found over North America includes an eye 22 wherein the pressure is considerably lower than that of the surrounding area. For example, a typical hurricane builds energy as it moves across the ocean drawing up warm moist tropical air from the surface and dispersing cooler air aloft The result is an intense, rotating ocean weather system that possesses maximum sustained wind speed in excess of 74 mph. At the ocean surface, the air speeds inward in a counter-clockwise direction. The cyclonic circulation becomes weak with height and essentially turns into a clockwise outflow near the top of the storm. Hurricanes form and intensify over ocean regions and require sea-surface temperatures of at least 80° F.

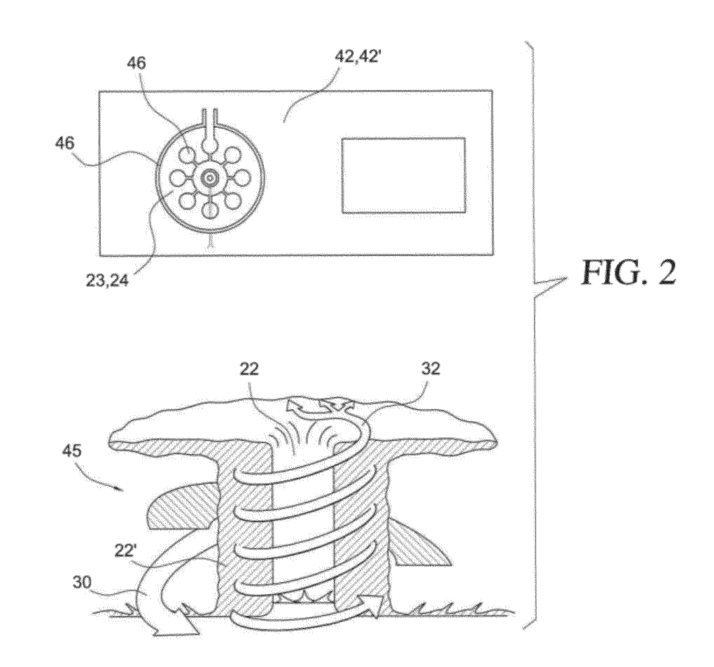

As illustrated in FIGS. 1 and 2, a pair of resonate cavity magnetrons 23 and 24 are dispersed in orbit above the eye 22 and eye wall 22′ (see FIG. 2) of the hurricane. Two resident cavity magnetrons 23 and 24 are placed in orbit above the pathway of a hurricane as for example in the North Atlantic Region of the United States by spaceships 42, 42′ (FIG. 1). The resident cavity magnetrons 23 and 24 direct and/or focus a beam of radiation at the base of the eye 22 or eye wall 22′. The second magnetron 24 directs and/or focuses a beam of energy at the upper level or top of the hurricane.

The magnetrons direct the RF energy to the base and the top of the hurricane. The first RF energy will be targeted at the base of the hurricane i.e. eye wall to disturb and weaken the hurricane wind force. The second RF energy will be targeted at the top level of the hurricane to reduce the condensation (maintain the warm water vapor).

The numeral 30 represents the rising warm moist air. As this air reaches the top of the storm it is carried away by horizontal upper atmospheric winds. The number 32 represents the storm surge within the eye of the hurricane. Such surges can raise the water level inside the eye 22 by 25 feet. Then as the hurricane hits land, the storm surge accounts for the majority of flooding and deaths associated with the hurricane.

As illustrated in FIG. 2, a system or device in accordance with a preferred embodiment of the invention includes or consists of two orbiting satellites 42 and 42′ each with a resonant cavity magnetron 23, 24 disposed therein. The magnetron or a plurality of magnetrons 23 and 24, each of which produce a frequency of 2,450 mghz or about that frequency at between 1 to 3 kw is powered by a plurality of solar cells 46 disposed in or on the satellites 42, 42′. It is also contemplated that two magnetrons can be mounted in two jet winged aircraft flown at different altitudes and used in the same manner as mentioned above.

The satellites 42, 42′ in the preferred embodiment of the invention are disposed above a coastline in an area that is prone to a pathway of a hurricane 45. The resident cavity magnetrons consist of an oxide coated cathode 46 with a high continuous or paused negative potential powered by a high voltage direct-current power supply. The cathode is built into or onto the center of an evacuated circular chamber. A magnetron field parallel to a filament is impaired by a permanent magnet. The magnetic field causes the electrons that are attributed to a positive outer part of a chamber to spiral outward in a circular path. Cylindrical cavities are spaced around the chamber, and open along their lengths and connect the cavities as shown. As electrons sweep past these openings they induce a resident high frequency radio field which in turn causes the electrons to bunch into groups. A portion of this field is extracted with an antenna that is connected to a wave guide. The wave guide directs the RF energy to the base and top of the hurricane 45 to warm the air and reduce condensation of the moisture and reduce the dangerous forces of a hurricane.

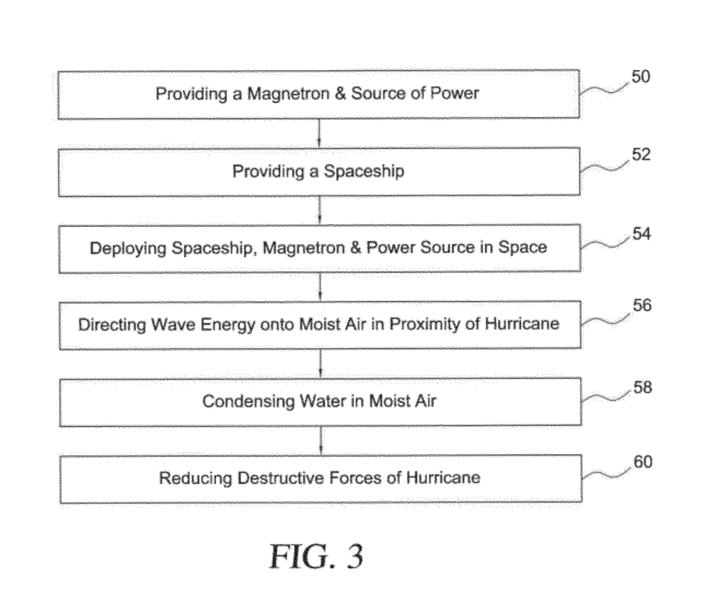

A method for reducing the destructive forces of a hurricane in accordance with a preferred embodiment of the invention will now be described in connection with FIG. 3. The method includes a step 50 of providing two resident cavity magnetrons or a plurality of such magnetrons and a source of direct current electrical energy as for example a series of rechargeable batteries that are recharged by an array of solar cells arranged on or in an outer area of a satellite or jet powered winged aircraft and directed to receive the sun's rays during daylight hours.

In a second step 52 a spaceship and/or rocket are provided for deploying a spaceship including one or more magnetrons together with a source of electrical energy in orbit above a coast line in an area prone to the pathway of a hurricane in step 54.

In a fourth step 56, the wave energy is directed by means of a wave guide onto the moist air in the proximity of a hurricane. Raising the temperature of the moisture produces larger condensed drops in step 58 that move the drops a further distance due to centrifugal force whereby the wind speed will be reduced, thus reducing the destructive forces of the hurricane in step 60.

While the invention has been described in connection with its preferred embodiment it should be recognized that changes and modifications may be made therein without departing from the scope of the appended claims.

What is claimed is:

1. A method for reducing the destructive forces of a hurricane comprising the steps of:
providing a magnetron that produces a frequency of about 2,450 mghz at 1,000 to 3,000 watts and deploying said magnetron in space over a coastal area; and
directing rays from said magnetron toward a layer of air in the projected path of a hurricane to reduce the temperature differential between the cold upper air and the warm rising air.

2. A method for reducing the destructive forces of a hurricane according to claim 1 in which the rays from the magnetron are directed onto or into the eye of a hurricane.

3. A method for reducing the destructive forces of a hurricane according to claim 2 in which a plurality of magnetrons are provided and deployed in space and wherein the rays of the magnetrons are directed onto the air circulating around the eye of the hurricane and at an upper level of the hurricane.

4. A method for reducing the destructive forces of a hurricane according to claim 3 in which the magnetrons are resonate cavity magnetrons.

5. A method for reducing the destructive forces of a hurricane according to claim 1 which includes the step of projecting the path of a hurricane and heating the upper cold air in front of a tropical storm path before the tropical storm reaches the level of a hurricane.

6. A method for reducing the destructive forces of a hurricane according to claim 3 which includes heating the cold upper air with the output of a first of said magnetrons before the storm reaches a coastal area and the step of heating a base of an eye wall after the hurricane forms with a second of said magnetrons.

7. A method for reducing the destructive forces of a hurricane consisting of the steps of:
providing a plurality of magnetrons each of which produces a frequency of about 2,540 mghz at 1,000 to 3,000 watts and deploying said magnetrons in space above a coast line to generate rays of 2,540 mghz and directing the energy from the magnetron onto an area surrounding the eye of a hurricane.

8. A system for reducing the destructive forces of a hurricane consisting of:
a first magnetron for producing a microwave with a frequency of 2,450 mghz at 1,000 to 3,000 watts and an energy source for continuously powering said magnetron;
a space ship for delivering said magnetron and said energy source into orbit in space above a coast line in a projected pathway of a hurricane and means for directing a series of microwaves into the air in the projected pathway of a hurricane; and
means for focusing said microwave on the air and moisture at an upper level of a hurricane and directing the energy generated by a second magnetron at the base of an eye wall of the hurricane.

9. A method for reducing the destructive forces of a hurricane comprising the steps of:
providing a magnetron that produces a frequency of about 2,450 mghz at about 1,000 to 3,000 watts and deploying said magnetron in an aircraft;
flying said aircraft with said magnetron into the area of a hurricane and directing the rays of said magnetron at the base of an eye wall of the hurricane to reduce the differential between the cold upper air and the rising warm air.

10. A method for reducing the disruptive forces of a hurricane according to claim 1 in which the aircraft makes a second pass into the area of the hurricane and directs the rays from the magnetron at an upper area of the hurricane.

11. A method for reducing the disruptive forces of a hurricane according to claim 9 in which two magnetrons each of which produce a frequency of about 2,450 mghz and about 1,000 to 3,000 watts and deploying said magnetrons in an aircraft, flying said aircraft with said magnetrons into the area of a hurricane at an altitude of about 1,000 to 1,200 meters and directing the rays from the magnetron of the first magnetron at the base of an eye wall of the hurricane to reduce the differential between the cold upper air and the rising warm air, and directing the rays of the second magnetron at an upper area of the hurricane.

12. A method for reducing the disruptive forces of a hurricane consisting of the steps of:
providing a magnetron that produces a frequency of about 2,450 mghz at about 1,000 to 3,000 watts and deploying said magnetron in an aircraft;
flying said aircraft with said magnetron into the area of a hurricane and directing the rays of said magnetron at the base of an eye wall of the hurricane to reduce the differential between the cold upper air and the rising warm air.
